(19) United States
(12) Patent Application Publication
(10) Pub. No.: US 2020/0181475 A1
(43) Pub. Date: Jun. 11, 2020

(54) SET ON DEMAND CEMENT

(71) Applicants: Shailesh Shashank Dighe, Katy, TX (US); D.V. Satyanarayana Gupta, Houston, TX (US); Harold D. Brannon, Magnolia, TX (US); Matthew Kellum, Spring, TX (US)

(72) Inventors: Shailesh Shashank Dighe, Katy, TX (US); D.V. Satyanarayana Gupta, Houston, TX (US); Harold D. Brannon, Magnolia, TX (US); Matthew Kellum, Spring, TX (US)

(73) Assignee: Baker Hughes, a GE company, LLC, Houston, TX (US)

(21) Appl. No.: 16/623,459

(22) PCT Filed: Jun. 20, 2018
(86) PCT No.: PCT/US2018/038495

§ 371 Date: Dec. 17, 2019

Related U.S. Application Data
(60) Provisional application No. 62/524,651, filed on Jun. 26, 2017.

(51) Int. Cl. C09K 8/467; C04B 28/02; C04B 20/10; C04B 22/12; C04B 12/04; C04B 40/06; E21B 33/14; E21B 33/12; E21B 41/00

(52) U.S. Cl. CPC C09K 8/467; C04B 28/02; C04B 20/1037; C04B 20/1033; C04B 22/124; C04B 2103/12; C04B 40/0641; E21B 33/14; E21B 33/12; E21B 41/00; C04B 12/04

(57) ABSTRACT

A method of cementing a wellbore comprises injecting into the wellbore a cement slurry comprising an encapsulated accelerant comprising an accelerant encapsulated within an encapsulation material; a cementitious material; and an aqueous carrier; and releasing the accelerant from the encapsulation material.

### CROSS REFERENCE TO RELATED APPLICATIONS

This application claims the benefit of U.S. Application No. 62/524651, filed on Jun. 26, 2017, which is incorporated herein by reference in its entirety.

### BACKGROUND

In the oil and gas industry, cementing is a technique employed during many phases of borehole operations. For example, cement may be employed to secure various casing strings and/or liners in a well. In other cases, cement may be used in remedial operations to repair casing and/or to achieve formation isolation. In still other cases, cement may be employed to isolate selected zones in the borehole and to temporarily or permanently abandon a borehole.

A cement slurry can be formed by mixing dry cement components with water using hydraulic jet mixers, re-circulating mixers, or batch mixers. Since the cement slurry has to remain pumpable before it reaches the desired location downhole, normally a cement slurry is used right after it is formed. In addition, once a cement slurry is injected into a wellbore, the set time can be affected by the temperature of the wellbore. As such, the set time is not controllable as it is desired by the users but rather ruled by the well conditions and the time when a cement slurry is formed. Accordingly, there is a need for methods that are effective to control the set time of the cement based on the user's demand.

### BRIEF DESCRIPTION

A method of cementing a wellbore comprises injecting into the wellbore a cement slurry comprising an encapsulated accelerant comprising an accelerant encapsulated within an encapsulation material; a cementitious material; and an aqueous carrier; and releasing the accelerant from the encapsulation material.

A cement slurry comprises: a encapsulated accelerant comprising an accelerant encapsulated within an encapsulation material, a cementitious material; and an aqueous carrier; wherein the accelerant comprises an alkali metal salt, an alkali earth metal salt, or a combination comprising at least one of the foregoing; and the encapsulation material comprises an epoxy, a phenolic resin, a melamine-formaldehyde, a polyurethane, a carbamate, a polycarbodiimide, a polyamide, a polyamide imide, a furan resin, a polyolefin, or a combination comprising at least one of the foregoing.

### BRIEF DESCRIPTION OF THE DRAWINGS

The following descriptions should not be considered limiting in any way. With reference to the accompanying drawings, like elements are numbered alike:

FIG. 1 illustrates an exemplary method of cementing a wellbore according to an embodiment of the disclosure;

FIG. 2 illustrates an exemplary method of cementing a wellbore according to another embodiment of the disclosure; and

FIG. 3 is a cross-sectional view of a plug having a wave emitter embedded therein.

### DETAILED DESCRIPTION

Methods are provided that are effective to decouple a cement slurry's set time from wellbore temperatures and the time when a cement slurry is formed. The methods include a mechanism which can controllably activate the cement slurry. Once activated, the cement slurries can quickly set. The methods allow for radically reduced set times as well as significantly reduced critical hydration periods. Set on demand methods also allow for safer placement of a cement slurry within a flexible time frame after the slurry is formed.

The cement slurry contains encapsulated accelerant. The accelerant can be released from the encapsulation material at a desired location and/or desired time by applying an energy wave to the encapsulated accelerant. The released accelerant accelerates the setting of the cement slurry.

Exemplary accelerants include alkali metal salts such as potassium chloride, alkaline earth metal salts such as calcium chloride, or a combination comprising at least one of the foregoing. In an embodiment, the accelerant is sodium meta silicate.

The accelerant is encapsulated in an encapsulating material to delay its release or contact with other components of the cement slurries. The encapsulating material is configured to release the accelerant in response to an energy wave.

In an embodiment, the encapsulation material is an organic compound that includes epoxy, phenolic, polyurethane, polycarbodiimide, polyamide, polyamide imide, furan resins, or a combination thereof. The phenolic resin is, e.g., a phenol formaldehyde resin obtained by the reaction of phenol, bisphenol, or derivatives thereof with formaldehyde. Exemplary thermoplastics include polyethylene, acrylonitrile-butadiene styrene, polystyrene, polyvinyl chloride, fluoroplastics, polysulfide, polypropylene, styrene acrylonitrile, nylon, and phenylene oxide. Exemplary thermosets include epoxy, phenolic (a true thermosetting resin such as resole or a thermoplastic resin that is rendered thermosetting by a hardening agent), polyester resin, polyurethanes, epoxy-modified phenolic resin, and derivatives thereof.

The encapsulation materials include cured, partially cured, or uncured polymers of, e.g., a thermoset or thermoplastic polymer. Curing the encapsulation material on the accelerant occurs before or after disposal of the encapsulated accelerant in the cement slurry or before or after disposal of the cement slurry downhole, for example.

The curing agent for the encapsulation material can be nitrogen-containing compounds such as amines and their derivatives; oxygen-containing compounds such as carboxylic acid terminated polyesters, anhydrides, phenol-formaldehyde resins, amino-formaldehyde resins, phenol, bisphenol A and cresol novolacs, phenolic-terminated epoxy resins; sulfur-containing compounds such as polysulfides, polymercaptans; and catalytic curing agents such as tertiary amines, Lewis acids, Lewis bases; or a combination thereof.

According to an embodiment, the encapsulation material is disposed on the accelerant by mixing in a vessel, e.g., a reactor. Individual components, e.g., the accelerant and encapsulation materials (e.g., reactive monomers used to form, e.g., an epoxy or polyamide coating) are combined in the vessel to form a reaction mixture and are agitated to mix the components. Further, the reaction mixture is heated at a temperature or at a pressure commensurate with forming a coating. In another embodiment, a coating comprising the encapsulation material is disposed on the accelerant via spraying such as by contacting the accelerant particles with a spray of the encapsulation material. The coated accelerant can be heated to induce crosslinking of the encapsulation material.

The amount of the encapsulated accelerant is not particularly limited and is generally in an amount sufficient to accelerate the setting of the cement slurry once the accelerant is released. The encapsulated accelerant can be present in the cement slurries in an amount of about 0.1 to about 10 wt. %, based on the weight of the cementitious material, preferably about 0.5 to about 5 wt. %, based on the weight of the cementitious material.

The accelerant can be released from the encapsulation material by applying an energy wave to the encapsulated accelerant. Suitable energy waves include sound waves, electromagnetic waves, or a combination comprising at least one of the foregoing. Exemplary energy waves include ultrasound, infrared radiation, microwave radiation, longitudinal wavers, transverse waves, and the like. The energy wave breaks the encapsulation material shell and release the accelerant.

In an embodiment, the energy wave is generated through a waver emitter disposed downhole. The wave emitter can be disposed of a float collar, a float shoe, a shoe trace, a plug, or a combination comprising at least one of the foregoing. The method can includes pumping the cement slurry into a tubular; and applying an energy wave to the encapsulated accelerant while the cement slurry passes the float collar, the shoe trace, the float shoe, the plug, or a combination comprising at least one of the foregoing. In another embodiment the method comprises pumping the cement slurry into an annulus between a tubular and a wall of the wellbore via the tubular; pumping a plug into the tubular, the plug having a wave emitter associated therewith; and applying an energy wave generated by the waver emitter to the encapsulated accelerant in the cement slurry disposed in the annulus between the tubular and a wall of the wellbore while the plug travels downhole in the tubular to release the accelerant from the encapsulating material.

Alternatively, the energy waver is generated at another location and directed to the cement slurry through a series of wave guides, a wireline, a coil tubing or the like. For example, the energy wave can be generated on the earth's surface and directed underground to the cement slurry.

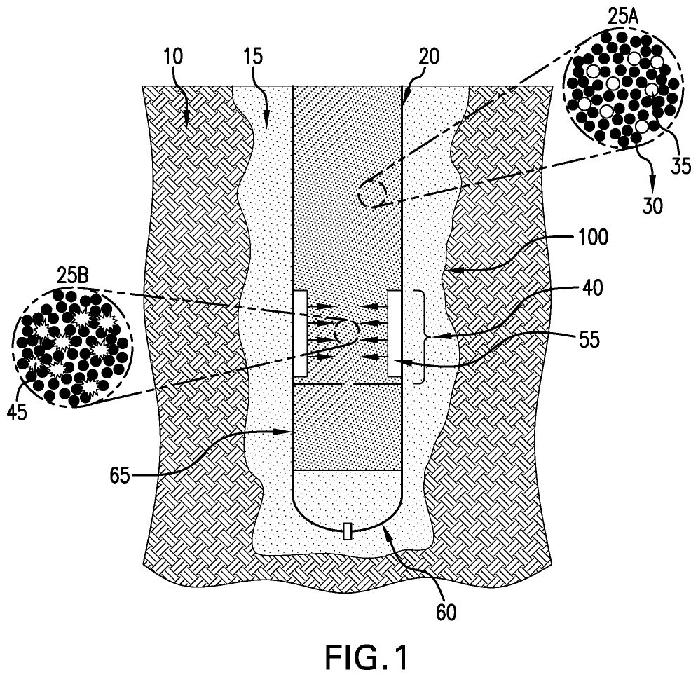

FIG. 1 illustrates an exemplary method of cementing a wellbore according to an embodiment of the disclosure. A wellbore 15 is drilled in an earth formation 10. Upon completion of wellbore drilling, a tubular 20 such as a casing string is placed in the wellbore 15. The tubular 20 has a float collar 40, a shoe track 65 and float shoe (also called guide shoe) 60. A cement slurry 25A containing encapsulated accelerant 35 as well as other components (collectively components 30) is pumped into the tubular 20. In the exemplary embodiment shown in FIG. 1, once the cement slurry passes the float collar 40, energy waves generated by the waver emitter 55 disposed of the float collar breaks encapsulation material (illustrated as 45) and releases the accelerant. The released accelerant along with other components of the cement slurry (collectively 25B) is pumped into the annular space between the tubular 20 and a wall 100 of the wellbore. Once placed, the cement slurries quick set, and in some embodiments, forms a cement plug in the wellbore annulus, which prevents the flow of reservoir fluids between two or more permeable geologic formations that exist with unequal reservoir pressures. Although in FIG. 1, the waver emitter is disposed of the shoe collar, it is appreciated that the waver emitter can also be disposed of the shoe track 65, float guide 60, or a penetrable/rupturable bottom plug (not shown) placed on the shoe collar, or a combination comprising at least one of the foregoing.

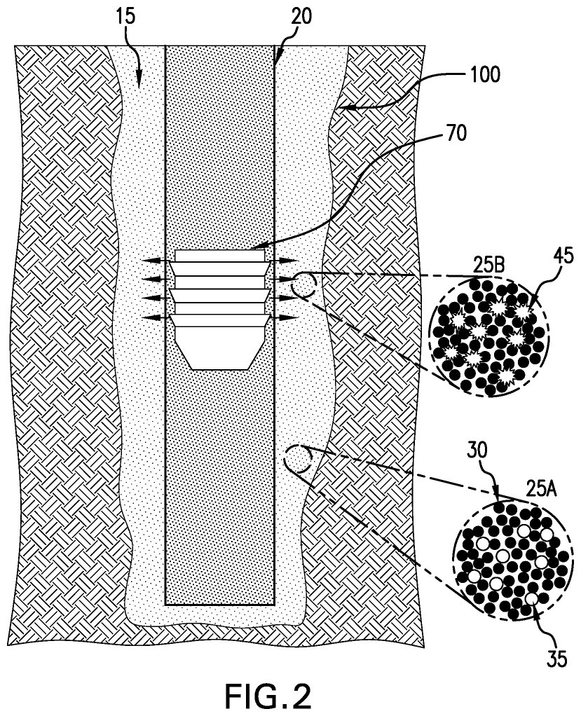

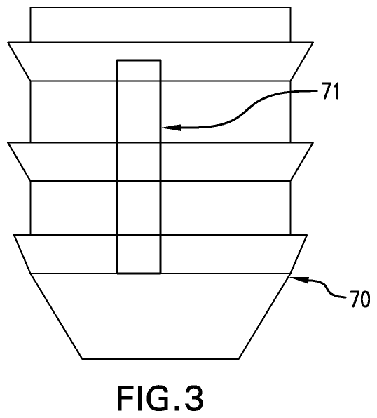

FIG. 2 illustrates another exemplary method of cementing a wellbore. In the method, a cement slurry 25A is pumped in to the annular space between a tubular 20 and a wall 100 of the wellbore 15 via the tubular. Then a plug such as a whip plug 70 is disposed in the tubular. The plug has a wave emitter 71 associated therewith. In an exemplary embodiment, the waver emitter 71 is embedded in the plug 70 as shown in FIG. 3. During the process of disposing the plug in the tubular, the wave emitter generates energy waves, which breaks the encapsulation material and releases the accelerant from the encapsulated accelerant in the cement slurry disposed between the tubular and a wall of the wellbore. The cement slurry rapidly cures subsequently securing the tubular to the walls of the wellbore.

The compositions of the cement slurries are described in detail. In addition to the encapsulated accelerant, the cement slurries further comprise a cementitious material. The cementitious material can be any material that sets and hardens by reaction with water, and is suitable for forming a set cement downhole, including mortars and concretes. Suitable cementitious materials, including mortars and concretes, can be those typically employed in a wellbore environment, for example those comprising calcium, magnesium, barium, aluminum, silicon, oxygen, and/or sulfur. Such cementitious materials include, but are not limited to, Portland cements, pozzolan cements, gypsum cements, high alumina content cements, silica cements, and high alkalinity cements, or combinations of these. Portland cements are particularly useful. In some embodiments, the Portland cements that are suited for use are classified as Class A, B, C, G, and H cements according to American Petroleum Institute, API Specification for Materials and Testing for Well Cements, and ASTM Portland cements classified as Type I, II, III, IV, and V.

The cementitious material can be present in the cement slurries in an amount of about 5 to about 60 wt. % based on the total weight of the composition, preferably about 10 to about 45 wt. % of the weight of the composition, more preferably about 15 to about 40 wt. %, based on the total weight of the composition.

The cement slurries can optionally contain aggregate. The term “aggregate” is used broadly to refer to a number of different types of both coarse and fine particulate material, including, but are not limited to, sand, gravel, slag, recycled concrete, silica, glass spheres, limestone, feldspar, and crushed stone such as chert, quartzite, and granite. The fine aggregates are materials that almost entirely pass through a Number 4 sieve (ASTM C 125 and ASTM C 33). The coarse aggregate are materials that are predominantly retained on a Number 4 sieve (ASTM C 125 and ASTM C 33). In an embodiment, the aggregate comprises sand such as sand grains. The sand grains can have a size from about 1 μm to about 2000 μm, specifically about 10 μm to about 1000 μm, and more specifically about 10 μm to about 500 μm. As used herein, the size of a sand grain refers the largest dimension of the grain. Aggregate can be present in an amount of about 10% to about 95% by weight of the cement slurries, 10% to about 85% by weight of the cement slurries, 10% to about 70% by weight of the cement slurries, 20% to about 80% by weight of the cement slurries, 20% to about 70% by weight of the cement slurries, 20% to about 60% by weight of the cement slurries, about 20% to about 40% by weight of the cement slurries, 40% to about 90% by weight of the cement slurries, 50% to about 90% by weight of the cement slurries, 50% to about 80% by weight of the cement slurry, or 50% to about 70% by weight of the cement slurries.

The cement slurries further comprise an aqueous carrier fluid. The aqueous carrier fluid is present in the cement slurries in an amount of about 0.5% to about 60% by weight, specifically in an amount of about 1% to about 40%, more specifically in an amount of about 1% to about 15% or about 2% to about 15% by weight, based on the total weight of the cement slurries. The aqueous carrier fluid can be fresh water, brine (including seawater), an aqueous base, or a combination comprising at least one of the foregoing. It will be appreciated that other polar liquids such as alcohols and glycols, alone or together with water, can be used in the carrier fluid. In an embodiment, the cement slurries comprise water in an amount of about 0.5% to about 60% by weight, specifically in an amount of about 1% to about 40%, more specifically in an amount of about 1% to about 15% or about 2% to about 15% by weight, based on the total weight of the cement slurries.

The brine can be, for example, seawater, produced water, completion brine, or a combination comprising at least one of the foregoing. The properties of the brine can depend on the identity and components of the brine. Seawater, for example, can contain numerous constituents including sulfate, bromine, and trace metals, beyond typical halide-containing salts. Produced water can be water extracted from a production reservoir (e.g., hydrocarbon reservoir) or produced from an underground reservoir source of fresh water or brackish water. Produced water can also be referred to as reservoir brine and contain components including barium, strontium, and heavy metals. In addition to naturally occurring brines (e.g., seawater and produced water), completion brine can be synthesized from fresh water by addition of various salts for example, KCl, NaCl, ZnCl₂, ZnBr₂, MgCl₂, CaCl₂, or CaBr₂ to increase the density of the brine, such as 15 or 10.6 pounds per gallon of brine. Completion brines typically provide a hydrostatic pressure optimized to counter the reservoir pressures downhole. The above brines can be modified to include one or more additional salts. The additional salts included in the brine can be NaCl, KCl, NaBr, MgCl₂, CaCl₂, CaBr₂, ZnBr₂, NH₄Cl, sodium formate, cesium formate, and combinations comprising at least one of the foregoing. The NaCl salt can be present in the brine in an amount of about 0.5 to about 36 weight percent (wt. %), about 0.5 to about 25 wt. %, specifically about 1 to about 15 wt. %, and more specifically about 3 to about 10 wt. %, based on the weight of the brine.

The cement slurries can further comprise various additives. Exemplary additives include a retarder, a high range water reducer or a superplasticizer; a reinforcing agent, a self-healing additive, a fluid loss control agent, a weighting agent to increase density, an extender to lower density, a foaming agent to reduce density, a dispersant to reduce viscosity, a thixotropic agent, a bridging agent or lost circulation material, a clay stabilizer, ductility control agents, or a combination comprising at least one of the foregoing. These additive components are selected to avoid imparting unfavorable characteristics to the cement slurries, and to avoid damaging the wellbore or subterranean formation. Each additive can be present in amounts known generally to those of skill in the art.

Retarders can retard the set time of the cement slurry until the cement slurry has reached its ultimate location within the subterranean formation. Exemplary retarders include lignosulfonates, organic acids, phosphonic acid derivatives, synthetic polymers (e.g., copolymers of 2-acrylamido-2-methylpropane sulfonic acid (“AMPS”) and unsaturated carboxylic acids), inorganic borate salts, and combinations thereof.

High range water reducers or superplasticizers can be grouped under four major types, namely, sulfonated naphthalene formaldehyde condensed, sulfonated melamine formaldehyde condensed, modified lignosulfonates, and other types such as polyacrylates, polystyrene sulfonates.

Reinforcing agents include fibers such as metal fibers and carbon fibers, silica flour, and fumed silica. The reinforcing agents act to strengthen the set material formed from the cement slurries.

Self-healing additives include swellable elastomers, encapsulated cement particles, and a combination comprising at least one of the foregoing. Self-healing additives are known and have been described, for example, in U.S. Pat. Nos. 7,036,586 and 8,592,353.

Fluid loss control agents can be present, for example a latex, latex copolymers, nonionic, water-soluble synthetic polymers and copolymers, such as guar gums and their derivatives, poly(ethyleneimine), cellulose derivatives, and polystyrene sulfonate.

Weighting agents are high-specific gravity and finely divided solid materials used to increase density, for example silica flour, fly ash, calcium carbonate, barite, hematite, ilemite, sideritewollastonite, hydroxyapatite, fluorapatite, chlorapatite and the like. In some embodiments, about 15 wt. % to about 55 wt. % of wollastonite is used in the cement slurries, based on the total weight of the cement slurries. Hollow nano- and microspheres of ceramic materials such as alumina, zirconia, titanium dioxide, boron nitride, and carbon nitride can also be used as density reducers.

Extenders include low density aggregates as described above, clays such as hydrous aluminum silicates (e.g., bentonite (85% mineral clay smectite), pozzolan (finely ground pumice of fly ash), diatomaceous earth, silica, e.g., a quartz and condensed silica fumed silica, expanded Pearlite, gilsonite, powdered coal, and the like.

The aqueous carrier fluid of the cement slurries can be foamed with a liquid hydrocarbon or a gas or liquefied gas such as nitrogen, or air. The fluid can further be foamed by inclusion of a non-gaseous foaming agent. The non-gaseous foaming agent can be amphoteric, cationic, or anionic. Suitable amphoteric foaming agents include alkyl betaines, alkyl sultaines, and alkyl carboxylates. Suitable anionic foaming agents can include alkyl ether sulfates, ethoxylated ether sulfates, phosphate esters, alkyl ether phosphates, ethoxylated alcohol phosphate esters, alkyl sulfates, and alpha olefin sulfonates. Suitable cationic foaming agents can include alkyl quaternary ammonium salts, alkyl benzyl quaternary ammonium salts, and alkyl amido amine quaternary ammonium salts. A foam system is mainly used in low pressure or water sensitive formations. A mixture of foaming and foam stabilizing dispersants can be used. Generally, the mixture can be included in the cement slurries in an amount of about 1% to about 5% by volume of water in the cement slurries.

Examples of suitable dispersants include but are not limited to naphthalene sulfonate formaldehyde condensates, acetone formaldehyde sulfite condensates, and glucan delta lactone derivatives. Other dispersants can also be used depending on the application of interest.

Clay stabilizers prevent a clay from swelling downhole upon contact with the water or applied fracturing pressure and can be, for example, a quaternary amine, a brine (e.g., KCl brine), choline chloride, tetramethyl ammonium chloride, or the like. Clay stabilizers also include various salts such as NaCl, CaCl₂, and KCl.

The pH of the cement slurries is about 7 to about 13, about 7 to about 10, about 7 to about 9 or about 7 to about 8. A buffering agent can be optionally included in the cement slurries. Exemplary buffering agents include 2-amino-2-hydroxmethyl-propane-1,3-diol (TRIS), phosphate, carbonate, histidine, BIS-TRIS propane, 3-(N-morpholino)propanesulfonic acid (MOPS), (4-(2-hydroxyethyl)-1-piperazineethanesulfonic acid (HEPES), 2-[[1,3-dihydroxy-2-(hydroxymethyl)propan-2-yl]amino]ethanesulfonic acid (TES), 4-(N-Morpholino)butanesulfonic acid (MOBS), 3-(N-morpholino)propanesulfonic acid (MOPS), 3-(N,N-Bis[2-hydroxyethyl]amino)-2-hydroxypropanesulfonic acid (DIPSO), N-Tris(hydroxymethyl)methyl]-3-amino-2-hydroxypropanesulfonic acid (TAPSO), triethanolamine (TEA), pyrophosphate, N-(2-Hydroxyethyl)piperazine-N′-(2-hydroxypropanesulfonic acid) (HEPPSO), piperazine-1,4-bis(2-hydroxypropanesulfonic acid) dehydrate (POPSO), tricine, glyccylglycine, bicine, N-[tris(hydroxymethyl)methyl]-3-aminopropanesulfonic acid (TAPS), taurine, ammonia, ethanolamine, glycineTRIS, piperazine-N,N′-bis(2-ethanesulfonic acid) (PIPES).

The solid content of the cement slurries is about 30 to about 90 wt. % based on the total weight of the cement slurries, preferably about 60 to about 90 wt. % based on the total weight of the cement slurries, more preferably about 65 to about 85 wt. %, based on the total weight of the cement slurries.

The density of the cement slurries can vary widely depending on downhole conditions. Such densities can include about 5 to about 17 or about 5 to about 12 pounds per gallon when foamed. When unfoamed the density of a cement slurries can vary with such densities between about 9 up to about 20, about 9 up to about 15 pounds per gallon, or about 10 to about 14 pounds per gallons, or about 11 up to about 13 pounds per gallon. The cement slurries can also be higher density, for example about 15 to about 27 pounds per gallon or about 15 to about 22 pounds per gallon.

The various properties of the cement slurries can be varied and can be adjusted according to well control and compatibility parameters of the particular fluid with which it is associated for example a drilling fluid. The cement slurries can be used to form downhole components, including various casings, seals, plugs, packings, liners, and the like. The cement slurries can be used in vertical, horizontal, or deviated wellbores.

In general, the components of the cement slurries can be premixed or is injected into the wellbore without mixing, e.g., injected “on the fly” where the components are combined as they are being injected downhole. Preferably the cement slurries are formed by blending the encapsulated accelerant, the cementitious material, the aggregate, and the aqueous carrier before the cement slurries are injected into the wellbore.

A pumpable or pourable cement slurries can be formed by any suitable method. In an exemplary embodiment, the components of the cement slurries are combined using conventional cement mixing equipment. The cement slurries can then be injected, e.g., pumped and placed by various conventional cement pumps and tools to any desired location within the wellbore to fill any desired shape form. In an embodiment, injecting the cement slurries comprises pumping the cement slurries via a tubular in the wellbore. For example, the cement slurries can be pumped into an annulus between a tubular and a wall of the wellbore via the tubular. Once the cement slurry has been placed and assumed the shape form of the desired downhole article, the cement slurries are allowed to set and form a permanent shape of an article, for example, a plug.

The method is particularly useful for cementing a wellbore, which includes injecting, generally pumping, into the wellbore the cement slurries at a pressure sufficient to displace a drilling fluid, for example a drilling mud, a cement spacer, or the like, optionally with a “lead cement slurry” or a “tail cement slurry”. The cement slurries can be introduced between a penetrable/rupturable bottom plug and a solid top plug. Once placed, the cement slurries are allowed to harden, and in some embodiments, forms a cement plug in the wellbore annulus, which prevents the flow of reservoir fluids between two or more permeable geologic formations that exist with unequal reservoir pressures.

The setting conditions can vary depending on the specific cement slurry used. For example, the cement slurries can be set at a temperature of about 50 to about 450 F, more specifically, from 150 to 250 F and a pressure of about 1000 to about 50000 psi, more specifically, from 1000 to 10000 psi in about 0.5 hours to about 24 hours, more specifically, in about 1 to about 12 hours.

Set forth are various embodiments of the disclosure.

Embodiment 1. A method of cementing a wellbore, the method comprising injecting into the wellbore a cement slurry comprising: an encapsulated accelerant comprising an accelerant encapsulated within an encapsulation material; a cementitious material; and an aqueous carrier; and releasing the accelerant from the encapsulation material.

Embodiment 2. The method of Embodiment 1, wherein the cement slurry further comprises an aggregate.

Embodiment 3. The method of Embodiment 1 or Embodiment 2, wherein releasing the accelerant comprises applying an energy wave to the encapsulated accelerant.

Embodiment 4. The method of Embodiment 3, wherein the energy wave is generated downhole.

Embodiment 5. The method of Embodiment 4, wherein the energy wave is generated by a wave emitter disposed of a float collar, a shoe track, or a float shoe, a plug, or a combination comprising at least one of the foregoing.

Embodiment 6. The method of Embodiment 5, wherein the method comprises: pumping the cement slurry into a tubular; applying the energy wave to the encapsulated accelerant while the cement slurry passes the float collar, the shoe trace, the float shoe, the plug, or a combination comprising at least one of the foregoing.

Embodiment 7. The method of Embodiment 4, wherein the method comprises: pumping the cement slurry into an annulus between a tubular and a wall of the wellbore via the tubular; disposing a plug in the tubular, the plug having a wave emitter associated therewith; and applying the energy wave generated by the wave emitter to the encapsulated accelerant in the cement slurry disposed in the annulus between the tubular and the wall of the wellbore while the plug travels downhole in the tubular to release the accelerant from the encapsulation material.

Embodiment 8. The method of any one of Embodiments 1 to 7, wherein the energy wave is generated at a surface of the wellbore and transmitted to a desired location downhole via a wireline, a coil tubing, or a wave guide.

Embodiment 9. The method of any one of Embodiments 1 to 8, wherein the energy wave comprises a sound wave, an electromagnetic wave, or a combination comprising at least one of the foregoing.

Embodiment 10. The method of any one of Embodiments 1 to 10, wherein the accelerant comprises an alkali metal salt, an alkali earth metal salt, or a combination comprising at least one of the foregoing.

Embodiment 11. The method of Embodiment 10, wherein the accelerant is sodium meta silicate.

Embodiment 12. The method of any one of Embodiments 1 to 11, wherein the encapsulation material comprises an epoxy, a phenolic resin, a melamine-formaldehyde, a polyurethane, a carbamate, a polycarbodiimide, a polyamide, a polyamide imide, a furan resin, a polyolefin, or a combination comprising at least one of the foregoing.

Embodiment 13. The method of any one of Embodiments 1 to 12, wherein the encapsulated accelerant is present in an amount of about 0.5 wt. % to about 10 wt. %, based on the total weight of the cementitious material.

Embodiment 14. The method of any one of Embodiments 1 to 13, wherein the cementitious material comprises Portland cement, pozzolan cement, gypsum cement, high alumina content cement, silica cement, high alkalinity cement, or a combination comprising at least one of the foregoing.

Embodiment 15. The method of any one of Embodiments 1 to 14, wherein the cement slurry further comprises an additive which comprises a retarder, a reinforcing agent, a self-healing additive, a fluid loss control agent, a weighting agent, an extender, a foaming agent, a dispersant, a thixotropic agent, a bridging agent or lost circulation material, a clay stabilizer, or a combination comprising at least one of the foregoing.

Embodiment 16. The method of any one of Embodiments 1 to 15, wherein the cement slurry remains pumpable at wellbore conditions until setting.

Embodiment 17. The method of any one of Embodiments 1 to 16, further comprising forming the cement slurry by blending the encapsulated accelerant, the cementitious material, the aggregate; and the aqueous carrier before injecting the cement slurry into the wellbore.

Embodiment 18. The method of any one of Embodiments 1 to 17, wherein the cement slurry comprises solids in an amount of about 30 wt. % to about 90 wt. % based on the total weight of the cement slurry.

Embodiment 19. The method of any one of Embodiments 1 to 18, further comprising allowing the cement slurry to set.

Embodiment 20. A cement slurry comprising: a encapsulated accelerant comprising an accelerant encapsulated within an encapsulation material; a cementitious material; and an aqueous carrier; wherein the accelerant comprises an alkali metal salt, an alkali earth metal salt, or a combination comprising at least one of the foregoing; and the encapsulation material comprises an epoxy, a phenolic resin, a melamine-formaldehyde, a polyurethane, a carbamate, a polycarbodiimide, a polyamide, a polyamide imide, a furan resin, a polyolefin, or a combination comprising at least one of the foregoing.

Embodiment 21. The cement slurry of Embodiment 20, further comprising a retarder.

Embodiment 22. The cement slurry of Embodiment 20 or Embodiment 21, further comprising aggregates.

Embodiment 23. The cement slurry of any one of Embodiments 20 to 22, wherein the accelerant is calcium chloride.

Embodiment 24. The cement slurry of any one of Embodiments 20 to 22, wherein the accelerant is sodium meta silicate.

All ranges disclosed herein are inclusive of the endpoints, and the endpoints are independently combinable with each other. “Or” means “and/or.” All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. The modifier “about” used in connection with a quantity is inclusive of the stated value and has the meaning dictated by the context (e.g., it includes the degree of error associated with measurement of the particular quantity).

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

1. A method of cementing a wellbore, the method comprising:
injecting into the wellbore a cement slurry (25A) comprising:
an encapsulated accelerant comprising an accelerant encapsulated within an encapsulation material;
a cementitious material; and
an aqueous carrier; and
releasing the accelerant from the encapsulation material.

2. The method of claim 1, wherein the cement slurry (25A) further comprises an aggregate.

3. The method of claim 1, wherein releasing the accelerant comprises applying an energy wave to the encapsulated accelerant.

4. The method of claim 3, wherein the energy wave is generated downhole.

5. The method of claim 4, wherein the energy wave is generated by a wave emitter (55, 71) disposed of a float collar (40), a shoe track (65), or a float shoe, a plug, or a combination comprising at least one of the foregoing.

6. The method of claim 5, wherein the method characterized by:
pumping the cement slurry (25A) into a tubular;
applying the energy wave to the encapsulated accelerant while the cement slurry (25A) passes the float collar (40), the shoe trace, the float shoe, the plug, or a combination comprising at least one of the foregoing.

7. The method of claim herein the method further comprises:
pumping the cement slurry (25A) into an annulus between a tubular and a wall (100) of the wellbore via the tubular;
disposing a plug in the tubular, the plug having a wave emitter (55, 71) associated therewith; and
applying the energy wave generated by the wave emitter (55, 71) to the encapsulated accelerant in the cement slurry (25A) disposed in the annulus between the tubular and the wall (100) of the wellbore while the plug travels downhole in the tubular to release the accelerant from the encapsulation material.

8. The method of claim 1, wherein the energy wave is generated at a surface of the wellbore and transmitted to a desired location downhole via a wireline, a coil tubing, or a wave guide.

9. The method of claim 1, wherein the energy wave comprises a sound wave, an electromagnetic wave, or a combination comprising at least one of the foregoing.

10. The method of claim 1, wherein the accelerant comprises an alkali metal salt, an alkali earth metal salt, or a combination comprising at least one of the foregoing.

11. The method of claim 10, wherein the accelerant is sodium meta silicate.

12. The method of claim 1, wherein the encapsulation material comprises an epoxy, a phenolic resin, a melamine-formaldehyde, a polyurethane, a carbamate, a polycarbodiimide, a polyamide, a polyamide imide, a furan resin, a polyolefin, or a combination comprising at least one of the foregoing.

13. The method of claim 12, wherein the encapsulated accelerant is present in an amount of about 0.5 wt. % to about 10 wt. %, based on the total weight of the cementitious material.

14. A cement slurry (25A) comprising:
a encapsulated accelerant comprising an accelerant encapsulated within an encapsulation material;
a cementitious material; and
an aqueous carrier;
wherein the accelerant comprises an alkali metal salt, an alkali earth metal salt, or a combination comprising at least one of the foregoing; and
the encapsulation material comprises an epoxy, a phenolic resin, a melamine-formaldehyde, a polyurethane, a carbamate, a polycarbodiimide, a polyamide, a polyamide imide, a furan resin, a polyolefin, or a combination comprising at least one of the foregoing.

15. The cement slurry (25A) of claim 14, wherein the accelerant is calcium chloride or sodium meta silicate.
